(19) United States
(12) Patent Application Publication
(10) Pub. No.: US 2006/0224733 A1
(43) Pub. Date: Oct. 5, 2006

(54) Server system, server apparatus, terminal apparatus and method for connection acknowledgement

(75) Inventor: Takashi Ueda, Kashiba-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/375,442

(22) Filed: Mar. 15, 2006

(30) Foreign Application Priority Data
Mar. 30, 2005 (JP) 2005-99013

(51) Int. Cl. G06F 15/173

(52) U.S. Cl. 709/224

(57) ABSTRACT

A server system is provided with a server apparatus and a terminal apparatus capable of logging in a predetermined mode of the server apparatus. The terminal apparatus comprises a transmitter for transmitting a connection acknowledgment signal at intervals of time to the server apparatus while remaining in a log-in state to the predetermined mode of the server apparatus. The server apparatus comprises a monitor for monitoring a presence of the connection acknowledgment signal received from the terminal apparatus and a controller for performing a forcible log-out processing when the connection acknowledgment signal is not detected for the predetermined length of time.

This application claims priority under 35 U.S.C. § 119 to Japanese Patent Application No. 2005-99013 filed on Mar. 30, 2005, the entire disclosure of which is incorporated herein by reference in its entireties.

### BACKGROUND OF THE INVENTION

1. Field of the Invention

The present invention relates to a server system including a server apparatus and a terminal apparatus, a server apparatus and a terminal apparatus used in the system, and a method for acknowledging a connection between a server apparatus and a terminal apparatus.

2. Description of the Related Art

There is known, for example, a server system which comprises a multi function peripheral (MFP) provided with a web server function and a group of user terminal apparatuses, each user terminal apparatus provided with a web browser for performing a log-in action to connect with a particular mode of the MFP to monitor an MFP system data on its display.

In this server system, when a browser is forcibly terminated by a user performing no log-out processing, such forcible termination of the browser is hardly acknowledged by the MFP as a server apparatus. Therefore, it is impossible to perform a normal log-out processing and the logged-in state is held. If the user restarts the web browser to try to log-in again in such state, the log-in action is rejected, resulting in a problem of user-unfriendliness. Also, the server apparatus remains at the logged-in state and will be unfavorable in the utilization of resource.

If a user is logging in a user mode which is assigned to only one user and the browser is forcibly terminated, the browser will inhibit other users from performing the log-in action, also resulting in the problem of user-friendliness and unfavorable utilization of resource.

Generally, in order to prevent the server apparatus from being held in the logged-in state, an automatic logging out is performed by a time-out action upon detecting that there is no access for a predetermined length of time by a user who has logged in. However, there still remains the problem that it is impossible to perform the log-in action as mentioned above until the time-out.

For solving the above described drawback, a server system is disclosed in Japanese Unexamined Laid-open Patent Publication No. 2003-108423, where a monitor apparatus is provided for monitoring the status of a web browser in a terminal apparatus and when the web browser is forcibly terminated without a log-out processing by a user, the monitor apparatus transmits such information to the server apparatus, and the server apparatus performs a log-out processing based on the information.

However, in the server system disclosed in the aforementioned Patent Publication, since the web browser in the terminal apparatus is monitored by the monitor apparatus, if a power supply of the terminal apparatus is abruptly cut, not only the browser is forcibly terminated but also the operation of the monitor apparatus is terminated. Therefore, the information showing the forcible termination of the browser, which has to be transmitted from the monitor apparatus, will not be transmitted to the server apparatus, and the server apparatus still remains at the logged-in state.

Also, since the monitor apparatus monitors the web browser, there is a problem that the structure and control of the monitor apparatus is complicated.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a server system, in which, when a terminal apparatus remaining at a logged-in state to a server apparatus is forcibly terminated without a log-out processing at the terminal apparatus, the server apparatus can promptly acknowledge such state to prevent the logged-in state from being held for a considerable length of time with its simple arrangement.

Among other potential advantages, some embodiments can provide a server apparatus for use in said server system.

Among other potential advantages, some embodiments can provide a terminal apparatus for use in said server system.

Among other potential advantages, some embodiments can provide a method for acknowledging a connection between a server apparatus and a terminal apparatus, in which, when the terminal apparatus remaining at a logged-in state to the server apparatus is forcibly terminated without a log-out processing at the terminal apparatus, the server apparatus can promptly acknowledge such state to prevent the logged-in state from being held for a considerable length of time with its simple arrangement.

According to a first aspect of the preferred embodiment of the present invention, a server system, comprises: a server apparatus and a terminal apparatus capable of logging in a predetermined mode of the server apparatus, wherein the terminal apparatus comprises a transmitter for transmitting a connection acknowledgment signal at intervals of time to the server apparatus while remaining at a logged-in state to the predetermined mode of the server apparatus, and the server apparatus comprises a monitor for monitoring a presence of the connection acknowledgment signal transmitted from the terminal apparatus and a controller for forcibly performing a forcible log-out processing when the connection acknowledgment signal is not detected for a predetermined length of time.

According to a second aspect of the preferred embodiment of the present invention, a server apparatus, comprises: a monitor for monitoring a presence of a connection acknowledgment signal transmitted at intervals of time from a terminal apparatus which has logged in a predetermined mode of the server apparatus; and a controller for forcibly performing a forcible log-out processing when the connection acknowledgment signal is not detected for a predetermined length of time.

According to a third aspect of the preferred embodiment of the present invention, a terminal apparatus being capable of logging in a predetermined mode of a server apparatus, comprises: a transmitter for transmitting a connection acknowledgment signal at intervals of time to the server apparatus while remaining in a logged-in state to the predetermined mode of the server apparatus.

According to a fourth aspect of the preferred embodiment of the present invention, a method for acknowledging a connection between a server apparatus and a terminal apparatus, comprises the steps of: transmitting a connection acknowledgment signal at intervals of time from the terminal apparatus to the server apparatus while the terminal apparatus remaining at a logged-in state to a predetermined mode of the server apparatus, monitoring a presence of the connection acknowledgment signal transmitted from the terminal apparatus at the server apparatus, and performing a forcible log-out processing against the terminal apparatus when the connection acknowledgment signal is not detected for a predetermined length of time.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a schematic view showing a server system according to one embodiment of the present invention;

FIG. 2 is a block diagram of a terminal apparatus used in the server system shown in FIG. 1;

FIG. 3 is a flowchart showing an example of operations of the server system shown in FIG. 1;

FIG. 4 is a flowchart showing another example of operations of the server system shown in FIG. 1;

FIG. 5 is a flowchart showing a further example of operations of the server system shown in FIG. 1; and

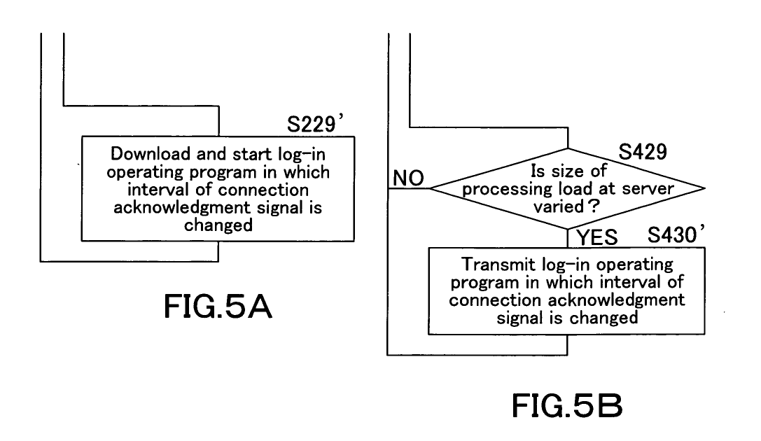

FIG. 6 is a flowchart showing another example of the server system shown in FIG. 1.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

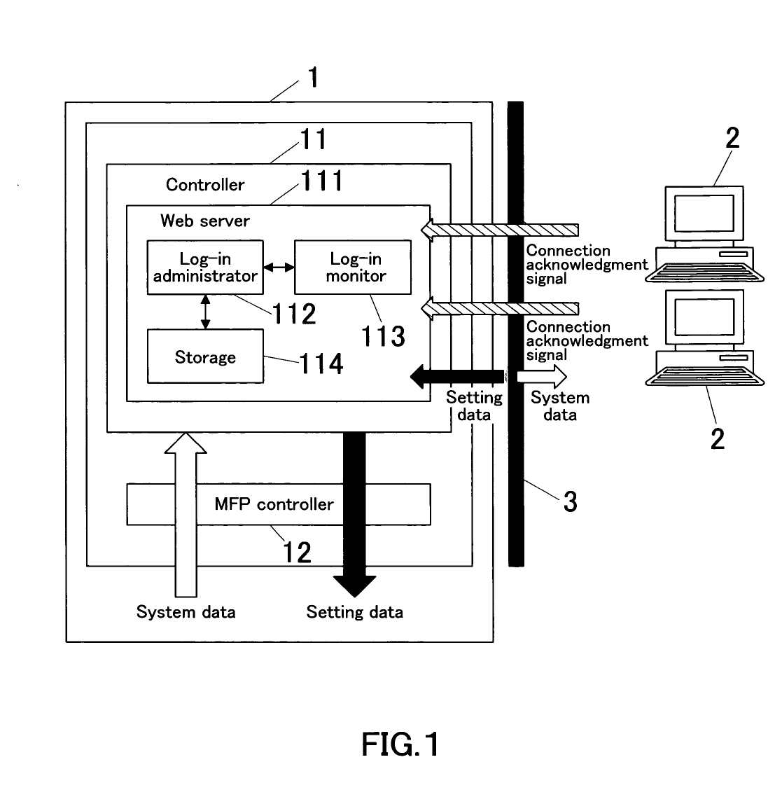

FIG. 1 is a schematic view of a server system in which an MFP 1 acting as a server apparatus is connected with one or more terminal apparatuses 2 (also referred to as a client PC hereinafter) comprising a personal computers or the like via a network 3.

The MPF 1 is a multi-function type image forming apparatus which has a copy function, a print function, a facsimile function, a scan function or the like and comprises a controller 11 to realize functions as a web server as well as a group of components (not shown) for carrying out the aforementioned functions. The general operation of the MFP 1 as an image forming apparatus is controlled by a general controller 12.

The controller 11 administrates and controls the client PC 2 which logs into a predetermined mode and has a web server 111 including a log-in administrator 112, a log-in monitor 113, a memory 114 and so on.

The log-in administrator 112 performs a user authentication processing, a log-in processing and a log-out processing or the like of a user who accesses from the client PC 2, and transmits a control program for transmitting a connection acknowledgment signal (referred to as a log-in operating program hereinafter) to the client PC 2 which has logged in. The user authentication may be conducted by either an external authentication apparatus or an internal authentication apparatus.

The log-in monitor 113 monitors a presence of a connection acknowledgment signal (as denoted by the hatching arrows in FIG. 1) which is periodically transmitted from the client PC 2 by the client PC 2's executing of the transmitted log-in operating program.

The memory 114 stores the log-in operating program which is to be transmitted to the client PC 2.

After logging in, the controller 11 also transmits an MFP system data stored in a system data storage (not shown) to the client PC 2 in response to a demand from the client PC 2, receives various setting data of an administrator or the like of the MFP 1 which has been logged in and stores it in a setting data storage (not shown).

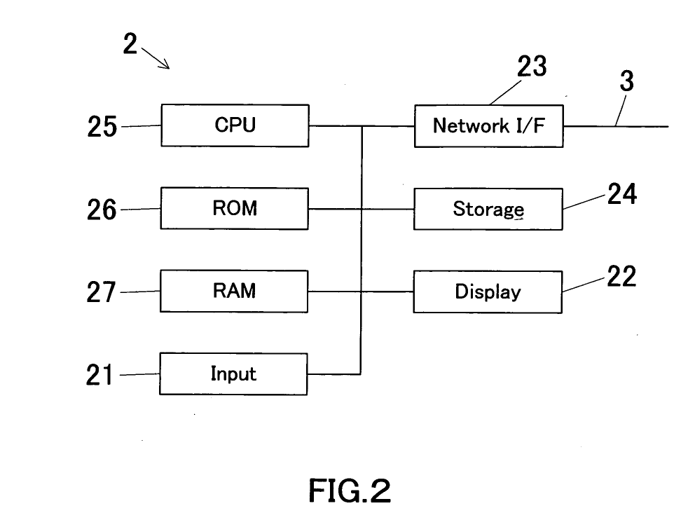

The client PC 2 includes, as shown in FIG. 2, an input 21, a display 22, a network interface 23 (denoted by Network I/F in the Figure), a storage 24, a CPU 25, a ROM 26, and a RAM 27. The client PC 2 also has a web browser which enables an access to the MFP 1.

The input 21 comprises a keyboard, a mouse or the like, and the display 22 comprises a liquid crystal display, a CRT or the like.

The network interface 23 is provided for communicating with the MFP 1 and other client PCs 2.

The storage 24 stores various information, browser softwares, and in this embodiment, the log-in operating program transmitted from the MFP 1 after log-in.

The CPU 25 executes programs stored in the ROM 26 and the storage 24 to control the general operations of the client PCs 2. Further, in this embodiment, the CPU 25 receives the log-in operating program from the MFP 1 via the network interface 23, makes the program stored in the storage 24 and executes the stored log-in operating program to periodically transmit a connection acknowledgment signal to the MFP 1. Moreover, when receiving an instruction from the MFP 1 to change an interval of transmission of the connection acknowledgment signal, the CPU 25 reflects it in the operating program stored in the storage 24. When receiving a new log-in operating program, the CPU 25 writes the existing program over. The log-in operating program is a software to be called up by a browser software and is written in JAVA Appllet, FLASH language or the like, for example.

The ROM 26 stores programs to be executed by the CPU 25 and necessary data, and the RAM 27 functions as a work area for the CPU 25 executing the programs.

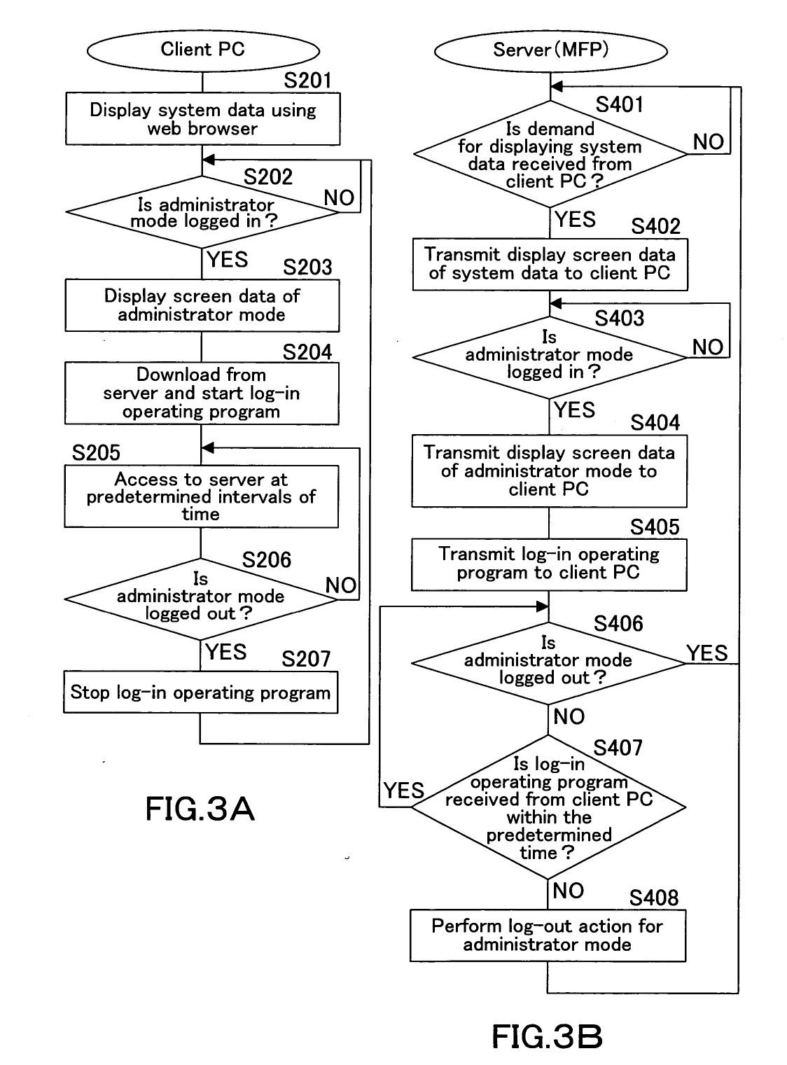

An example of the operations of the server system shown in FIG. 1 will now be described in conjunction with a flowchart of FIG. 3A showing processing of the CPU 25 in the client PC 2 and a flowchart of FIG. 3B showing processing of the controller 11 of the MFP 1 (referred to as a server hereinafter).

In this embodiment, an example in which a user operating the client PC 2 is an administrating user and the administrating user logs into an administrator mode of the server 1 will be described.

As shown in FIG. 3A, the client PC 2 shows system data on the display 22 by the web browser (Step S201), and then waits for log-in to the administrator mode (Step S202).

When the administrator mode is logged in (YES at Step S202), display screen of the administrator mode is displayed on the display 22 (Step S203), and then the log-in operating program transmitted from the server 1 is downloaded and operations are started (Step S204). In accordance with the log-in operating program, the access to the server 1 is repeated at predetermined intervals (Step S205). In other words, the connection acknowledgment signal is periodically transmitted to a URL (a uniform resource locator) in the server 1.

Then, it is examined whether or not the administrator mode is logged out (Step S206). If it is not logged-out (NO at Step S206), the processing returns to Step S205 and repeats the processing of S205 and S206.

If the administrator mode is logged-out (YES at Step S206), the log-in operating program is stopped (Step S207) and the procedure returns back to Step S202.

Meanwhile, as shown in FIG. 3B, the controller 11 in the server 1 waits for a request for displaying the system data from the client PC 2 (Step S401). If the request is made (YES at S401), display screen of the system data is transmitted to the client PC 2 (Step S402).

It is then determined whether or not the administrator mode is logged in (Step S403). If the administrator mode is not logged in (no at Step S403), the processing remains at Step S403.

If the administrator mode is logged in (YES at S403), the display screen of the administrator mode is transmitted to the client PC 2 (Step S404) and the log-in operating program is transmitted to the client PC 2 (Step S405).

It is then examined whether or not the user logged out the administrator mode (Step S406). If the administrator mode is logged out (YES at S406), the processing returns to Step S401 to wait for a fresh request from the client PC 2 to display the system data.

If the administrator mode is not logged out (NO at Step S406), it is then determined whether there is an access from the log-in operating program of the client PC 2 within a predetermined time or not, in other words, whether the connection acknowledgment signal is transmitted or not (Step S407).

If there is an access (YES at Step S407), the processing returns to Step S406 for repeating the determining steps of Steps S406 and S407, because the browser at the client PC 2 is not forcibly terminated. If there is no access (NO at Step S407), it is determined that the browser at the client PC 2 is forcibly terminated and the administrator mode is forcibly logged out (Step S408), and the processing returns to Step S401.

In this embodiment, the server 1 transmits the log-in operating program to the client PC 2 which has logged into the administrator mode, and the client PC 2 monitors the connection acknowledgment signal transmitted periodically from the client PC 2 by executing the log-in operating program. If the connection acknowledgment signal is disconnected, it is determined that the browser at the client PC 2 has forcibly been terminated, and the log-out processing is forcibly executed. This prevents the log-in state from being held for a unwanted length of time. Therefore, disadvantages such as rejection of user's re-login for a long time and disenabling of other users' login will be eliminated.

Also, in the present invention, the web browser is not monitored to transmit a signal when the browser is forcibly terminated. In contrast, the client PC 2 transmits the connection acknowledgment signal periodically to the server 1 and the server 1 monitors the signal. Therefore, even if the power of the client PC 2 is accidentally turned off, the server apparatus can assuredly grasp the forcible termination of the browser from the fact that there is no connection acknowledgment signal from the client PC 2. Further, overall structure and control of the present invention can be simplified in comparison with the structure in which the web browser of the client PC 2 is monitored.

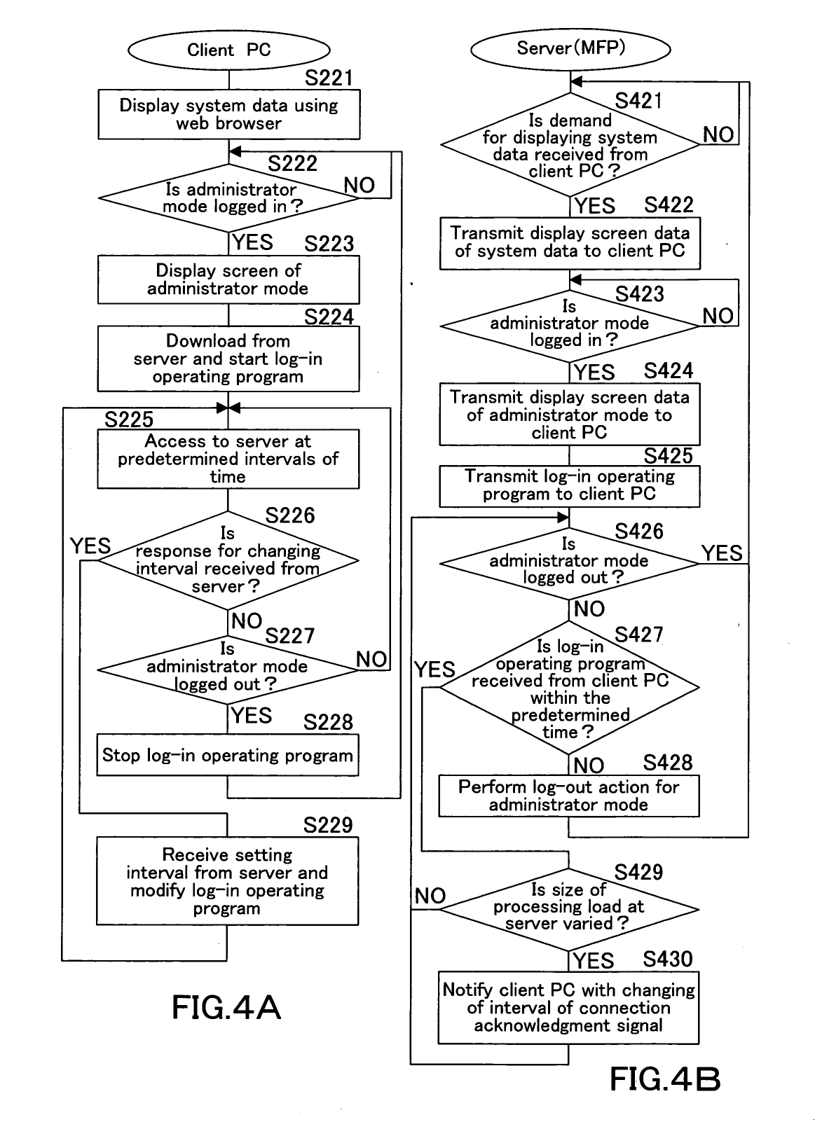

Next, another example of the operation of the server system shown in FIG. 1 will be described in conjunction with a flowchart of FIG. 4A showing processing of the CPU 25 in the client PC 2 and a flowchart of FIG. 4B showing processing of the controller 11 in the server 1.

In this embodiment, a time cycle of the connection acknowledgment signal transmitted from the client PC 2 is varied depending on the state of processing load of the server 1.

As shown in FIG. 4A, the client PC 2 displays the system data on its display 22 by web browser (Step S221), and waits for the login to the administrator mode (Step S222).

When the administrator mode is logged in (YES at Step S222), the display screen of the administrator mode is displayed on the display 22 (Step S223) and the log-in operating program transmitted from the server 1 is downloaded and operations are started (Step S224). In accordance with the log-in operating program, an access to the server 1 is made at predetermined intervals (Step S225). In other words, the connection acknowledgment signal is periodically transmitted to the URL in the server 1.

Then, it is examined whether there is a response from the server 1 to change the interval of the connection acknowledgment signal or not in response to the access to the server 1 (Step S226). If there is the response (YES at Step S226), the interval of the connection acknowledgment signal is received from the server and reflected to the log-in operating program (Step S229). Then the processing returns to Step S225 to transmit the connection acknowledgment signal at changed intervals of time.

On the other hand, if there is no response to change the interval of the connection acknowledgment signal from the server 1 (NO at Step S226), it is examined whether the administrator mode is logged out or not (Step S227). If it is not logged out (NO at Step S227), the processing returns to Step S225.

If it is logged out (YES at Step S227), the log-in operating program is stopped (Step S228) and the processing returns to Step S222.

Meanwhile, as shown in FIG. 4B, the controller 11 in the server 1 waits for a request to display the system data from the client PC (Step S421). If the request is made (YES at S421), the display screen of the system data is transmitted to the client PC 2 (Step S422).

Then, it is determined whether or not the administrator mode is logged in (Step S423). If the administrator mode is not logged in (NO at Step S423), the processing remains at Step S423.

If the administrator mode is logged in (YES at S423), the display screen of the administrator mode is transmitted to the client PC 2 (Step S424) and the log-in operating program is transmitted to the client PC 2 (Step S425).

Then it is examined whether the user logged out the administrator mode or not (Step S426). If the administrator mode is logged out (YES at S426), the processing returns to Step S421 to wait for a fresh request from the client PC 2 to display the system data.

If the administrator mode is not logged out (NO at Step S426), it is determined whether there is an access from the log-in operating program of the client PC 2 within the predetermined time or not, in other words, whether the connection acknowledgment signal is transmitted or not (Step S427).

If there is no access (NO at Step S427), it is determined that the browser is forcibly terminated, and the forcible log-out operation of the administrator mode is executed (Step S428) and the processing returns to Step S421.

If there is an access (YES at Step S427), it is examined whether there is a change in the state of the processing load at the server (Step S429). If there is a change in the state of the processing load (YES at Step S429), a change of the interval of the connection acknowledgment signal is instructed to the client PC 2 in response to the connection acknowledgment signal (Step S430) and the processing returns to Step S426. If there is no change (NO at Step S429), the processing returns to Step S426.

For example, if the processing load at the server 1 is heavy, the interval of the connection acknowledgment signal is extended to restrain the increase of the processing load. On the contrary, when the processing load at the server 1 is light, the interval of the connection acknowledgment signal is shortened since there is no problem even if the load is increased. The degree of the processing load at the server 1 may be determined based on the number of jobs stored in a printing queue, or whether an operation panel is used or not, and so on.

Even if the processing load at the server 1 is heavy, when the number of the users who are logging in the server 1 is large, for example, the interval of the connection acknowledgment signal is shortened to have the user whose browser has been forcibly terminated log out forcibly as quickly as possible so that the load at the server will be diminished.

If there arise a further change in the state of the processing load at the server 1 after responding to change the interval of the connection acknowledgment signal, the further change of the interval may be instructed to the client PC 2 accordingly.

As described above, since the server 1 in this embodiment changes the interval of the connection acknowledgment signal according to the state of the processing load at the server 1, it can execute an optimum connection acknowledgment processing according to the state of the processing load.

In the embodiment shown in FIG. 4, if it is desired to change the interval of the connection acknowledgement signal, the server 1 transmits an instruction to change the interval to the client PC 2 at Step S430 and the client PC reflects the instruction to the log-in operating program at Step S229. Alternatively, in replace of Steps S430 and S229, the server 1 may transmit a fresh program in which the interval of the connection acknowledgment signal has been changed at Step S430′, and the client PC 2 may download the fresh program and commence operations in accordance with the program at Step S229′.

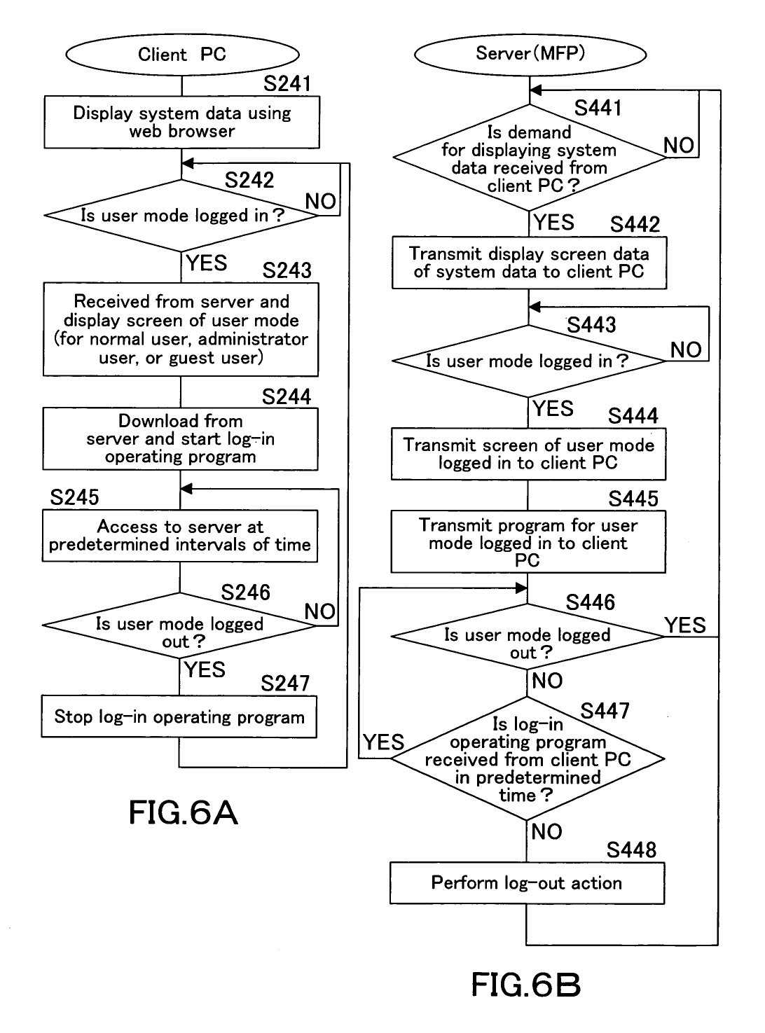

Next, another example of the operations of the server system shown in FIG. 1 will be described in conjunction with a flowchart of FIG. 6A showing processing of the CPU 25 in the client PC 2 and a flowchart of FIG. 6B showing processing of the controller 11 in the server 1.

In this embodiment, the interval of the connection acknowledgment signal transmitted from the client PC 2 is varied on the basis of the types of log-in mode, such as normal user mode, guest user mode, administrator user mode, and so on.

As shown in FIG. 6A, at the client PC 2, the system data is displayed on its display 22 by the web browser (Step S241) and waits for login to a predetermined user mode (Step S242).

If the user mode is logged in (YES at Step S242), a display screen according to the kind of the user mode transmitted from the server 1 is displayed on the display (Step S243) and the log-in operating program transmitted from the server 1 is downloaded and operations are started (Step S244). The access to the server 1 is made according to the log-in operation program in the predetermined intervals (Step S245). In other words, the connection acknowledgment signal is periodically transmitted to the URL in the server 1.

Then it is examined whether the user logged out the user mode or not (Step S246). If it is not logged out (NO at Step S246), the processing returns to Step S245.

If it is logged out (YES at Step S246), the log-in operating program is stopped (Step S247) and the processing returns to Step S242.

Meanwhile, as shown in FIG. 6B, the controller 11 in the server 1 waits for a request from the client PC 2 to display the system data (Step S441). If the request is made (YES at S441), the display screen of the system data is transmitted to the client PC 2 (Step S442).

Next, it is examined whether or not the predetermined user mode is logged in (Step S443). If the predetermined user mode is not logged in (NO at Step S443), the procedure remains at Step S443.

If it is logged in (YES at S443), screen data corresponding to the logged in user mode is transmitted to the client PC 2 (Step S444) and a log-in operating program corresponding to the user mode is transmitted to the client PC 2 (Step S445).

It is then examined whether the user logged out or not (Step S446). If it is logged out (YES at S446), the processing returns to Step S441 to wait for a fresh command of displaying the system data from the client PC 2.

If it is not logged out (NO at Step S446), it is then determined whether there is an access from the log-in operating program of the client PC 2 within the predetermined time. In other words, it is determined whether the connection acknowledgment signal is transmitted from the client PC 2 (Step S447).

If there is no access (NO at Step S447), it is determined that the browser is forcibly terminated, and the processing returns to Step S441 after the forcible logout processing is executed (Step S448).

If there is an access (YES at Step S447), the processing returns to Step S446, because the client PC 2 remains connected with the aforementioned mode.

In this embodiment, the log-in operating programs transmitted to the client PC 2 are set to have different interval of the connection acknowledgment signal depending on the types of the logged-in user mode.

For example, if the interval of the connection acknowledgment signal of each of the guest user mode, the normal user mode and the administrator user mode is T1, T2 and T3, respectively, the relationship of T1<T2<T3 is established. Because the number of users who are able to log-in increases in an order of the administrator user mode, the normal user mode and the guest user mode, the users who are logging in the user mode to which the more number of the users can log-in will be forcibly logged out as soon as possible so as to give an opportunity to other users to log in.

Further, the types of the mode are not limited to the guest user mode, the normal user mode, and the administrator user mode. For example, a power user mode may be set between the normal user mode and the administrator user mode. To the power user mode, a power user, who has an authorization to delete MFP internal factors, which is not permitted to the normal user, but has a narrower authorization than the administrator user, can log in. The interval of the connection acknowledgment signal T4 for the power user mode may establish the relationship of T1<T2<T4<T3.

Alternatively, the user mode may be divided into two modes, i.e., the normal user mode and the administrator user mode, and the length of the interval of the connection acknowledgment signal T2 of the normal user mode and the connection acknowledgment signal T3 of the administrator user mode may be settled treating security as a priority. That is, the relationship of T2>T3 may be settled to have a user in the administrator user mode having a greater authorization log out as soon as possible when its browser has forcibly been terminated, in order to eliminate any ill-intentioned changing of the system settings of the MFP 1. Alternatively, as described above, the relationship of T2<T3 may be settled in order to give an opportunity to a large number of normal users.

Further, the interval of transmission of the connection acknowledgment signal may be varied depending on the type of the terminal apparatus 2 instead of the user mode. For example, when the terminal apparatus 2 is a device of MFP or the like, and an access is made from an operation panel of such device, the risk that the power of the device is turned off is higher than a personal computer. Thus, the relationship of the interval of the connection acknowledgment signal T6 for the MFP terminal and the interval of the connection acknowledgment signal T7 for the personal computer may be settled to: T6<T7.

It should be understood that the present invention is not limited to the foregoing embodiment described above.

For example, in the aforementioned embodiment, the log-in operation program is transmitted from the server 1 to the terminal apparatus 2 and the connection acknowledgment signal is periodically transmitted from the terminal apparatus 2 to the server 1. Alternatively, the terminal apparatus 2 may be provided with the log-in operation program from the beginning, and the log-in operation program may be operated when the server 1 is logged in, and outputs the connection acknowledgment signal. It is, however, preferred that the log-in operating program is transmitted from the server 1 to the terminal apparatuses 2, because the operation program can be retained only in a required terminal apparatus, and the change of interval of the connection acknowledgment signal can be easily conducted.

Although the server 1 is an MFP in the aforementioned embodiment, it may be a personal computer or any other applicable apparatus.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

What is claimed is:

1. A server system, comprising a server apparatus and a terminal apparatus capable of logging in a predetermined mode of the server apparatus,
wherein the terminal apparatus comprises a transmitter for transmitting a connection acknowledgment signal at intervals of time to the server apparatus while remaining at a logged-in state to the predetermined mode of the server apparatus, and
the server apparatus comprises a monitor for monitoring a presence of the connection acknowledgment signal transmitted from the terminal apparatus and a controller for forcibly performing a forcible log-out processing when the connection acknowledgment signal is not detected for a predetermined length of time.

2. The server system as recited in claim 1, wherein the server apparatus is an image forming apparatus and the terminal apparatus comprises a display for displaying information of the image forming apparatus.

3. The server system as recited in claim 1, wherein the server apparatus comprises a program transmitter for transmitting a control program for transmitting the connection acknowledgment signal to the terminal apparatus which has logged in, and the terminal apparatus transmits the connection acknowledgment signal by executing the control program.

4. The server system as recited in claim 3, wherein the server apparatus changes an interval of transmission of the connection acknowledgment signal to be transmitted from the terminal apparatus depending on a status of the server apparatus.

5. The server system as recited in claim 3, wherein the server apparatus changes an interval of transmission of the connection acknowledgment signal to be transmitted from the terminal apparatus depending on a mode to which the terminal apparatus logged in.

6. A server apparatus comprising:
a monitor for monitoring a presence of a connection acknowledgment signal transmitted at intervals of time from a terminal apparatus which has logged in a predetermined mode of the server apparatus; and
a controller for forcibly performing a forcible log-out processing when the connection acknowledgment signal is not detected for a predetermined length of time.

7. The server apparatus as recited in claim 6, wherein the server apparatus comprises an image forming apparatus, and the server apparatus is capable of providing system data to the terminal apparatus which has logged in the server apparatus.

8. The server apparatus as recited in claim 6, further comprising a program transmitter for transmitting a control program for transmitting the connection acknowledgment signal to the logged-in terminal apparatus.

9. The server apparatus as recited in claim 8, wherein the server apparatus changes an interval of transmission of the connection acknowledgment signal to be transmitted from the terminal apparatus depending on a status of the server apparatus.

10. The server apparatus as recited in claim 8, wherein the server apparatus changes an interval of transmission of the connection acknowledgment signal to be transmitted from the terminal apparatus depending on a mode to which the terminal apparatus logged in.

11. A terminal apparatus being capable of logging in a predetermined mode of a server apparatus, comprising:
a transmitter for transmitting a connection acknowledgment signal at intervals of time to the server apparatus while remaining in a logged-in state to the predetermined mode of the server apparatus.

12. The terminal apparatus as recited in claim 11, further comprising a receiver for receiving a control program for transmission of the connection acknowledgment signal to be transmitted from the server apparatus while remaining at the log-in state to the predetermined mode of the server apparatus,
wherein the transmitter transmits the connection acknowledgment signal by executing the control program.

13. The terminal apparatus as recited in claim 12, wherein the transmitter changes an interval of transmission of the connection acknowledgment signal depending on a state of the server apparatus.

14. The terminal apparatus as recited in claim 12, wherein the transmitter changes an interval of transmission of the connection acknowledgment signal depending on a mode of the server apparatus to which the terminal apparatus has logged in.

15. A method for acknowledging a connection between a server apparatus and a terminal apparatus, comprising the steps of:
transmitting a connection acknowledgment signal at intervals of time from the terminal apparatus to the server apparatus while the terminal apparatus remaining at a logged-in state to a predetermined mode of the server apparatus,
monitoring a presence of the connection acknowledgment signal transmitted from the terminal apparatus at the server apparatus, and
performing a forcible log-out processing against the terminal apparatus when the connection acknowledgment signal is not detected for a predetermined length of time.
